(19) United States
(12) Patent Application Publication
(10) Pub. No.: US 2025/0384447 A1
(43) Pub. Date: Dec. 18, 2025

(54) ENHANCED AUTOMATED SERVICE SYSTEMS AND METHODS

(71) Applicant: Glory Ltd., Hyogo (JP)

(72) Inventor: Russell BRACKETT, Powder Springs, GA (US)

(73) Assignee: Glory Ltd., Hyogo (JP)

(21) Appl. No.: 18/741,860

(22) Filed: Jun. 13, 2024

(51) Int. Cl. G06Q 20/40; G06Q 20/10; G06Q 20/22

(52) U.S. Cl. CPC G06Q 20/405; G06Q 20/1085; G06Q 20/227; G06Q 20/4014

(57) ABSTRACT

In some implementations, an automated service system may obtain account information associated with a set of accounts managed by an entity and generate, based on the account information, a set of allowable transactions associated with the set of accounts and a set of rules that govern performance of the set of allowable transactions. The automated service system may provide a graphical user interface (GUI) that displays the set of allowable transactions and receive, via the GUI, user input indicating a selection of one or more allowable transactions, included in the set of allowable transactions, associated with one or more accounts included in the set of accounts. The automated service system may generate an account rule data structure that indicates the one or more allowable transactions and one or more rules, included in the set of rules, corresponding to the one or more allowable transactions.

### BACKGROUND

Automated service systems allow users to independently perform tasks or transactions without direct assistance (e.g., assistance from a representative associated with an entity). For example, an automated teller machine (ATM) allows users to perform basic financial transactions without direct assistance from a teller of a bank.

### SUMMARY

Some implementations described herein relate to a system, comprising: one or more memories; and one or more processors, communicably coupled to the one or more memories, configured to: obtain account information associated with a set of accounts managed by an entity; generate, based on the account information, a set of allowable transactions associated with the set of accounts and a set of rules that govern performance of the set of allowable transactions; provide a graphical user interface (GUI) that displays the set of allowable transactions; receive, via the GUI, user input indicating a selection of one or more allowable transactions, included in the set of allowable transactions, associated with one or more accounts included in the set of accounts; and generate an account rule data structure that indicates the one or more allowable transactions and one or more rules, included in the set of rules, corresponding to the one or more allowable transactions.

Some implementations described herein relate to medium processing device, comprising: one or more memories; and one or more processors, communicably coupled to the one or more memories, configured to: provide a graphical user interface (GUI) enabling interaction of a user; receive one or more authentication credentials associated with the user; authenticate the one or more authentication credentials to confirm an identity of the user; obtain, using the identity of the user, user account data indicating one or more user account identifiers of one or more user accounts managed by an entity; determine that the one or more user account identifiers of the one or more user accounts match one or more entity account identifiers of one or more entity accounts managed by the entity, wherein the one or more entity accounts are associated with one or more allowable transactions, and wherein performance of the one or more allowable transactions is governed by one or more rules; display, via the GUI, a set of user transaction options corresponding to the one or more allowable transactions; receive, via the GUI, user input indicating a selection of a user transaction option, included in the set of user transaction options, corresponding to an allowable transaction of the one or more allowable transactions, wherein the allowable transaction is associated with an entity account of the one or more entity accounts; and perform the allowable transaction according to the one or more rules.

Some implementations described herein relate to a non-transitory computer-readable medium that stores a set of instructions for a system. The set of instructions, when executed by one or more processors of the system, cause the system to obtain account information associated with a set of accounts managed by an entity; generate, based on the account information, a set of allowable transactions associated with the set of accounts and a set of rules that govern performance of the set of allowable transactions; provide a graphical user interface (GUI) that displays the set of allowable transactions; receive, via the GUI, user input indicating a selection of one or more allowable transactions included in the set of allowable transactions, wherein the one or more allowable transactions are associated with one or more accounts included in the set of accounts; and generate an account rule data structure that indicates the one or more allowable transactions and one or more rules, included in the set of rules, corresponding to the one or more allowable transactions.

### BRIEF DESCRIPTION OF THE DRAWINGS

FIGS. 1A-1I are diagrams of an example associated with enhanced automated service systems and methods, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of a device associated with enhanced automated service systems and methods, in accordance with some embodiments of the present disclosure.

FIG. 4 is a flowchart of an example process associated with enhanced automated service systems and methods, in accordance with some embodiments of the present disclosure.

FIG. 5 is a flowchart of an example process associated with enhanced automated service systems and methods, in accordance with some embodiments of the present disclosure.

### DETAILED DESCRIPTION OF EXAMPLE EMBODIMENTS

The following detailed description of example implementations refers to the accompanying drawings. The same reference numbers in different drawings may identify the same or similar elements.

Typical automated service systems (e.g., self-service systems and/or self-service applications), including those integrated into in-lobby kiosks, often have a limited system architecture. This limited system architecture presents challenges and drawbacks. For example, typical automated service systems are designed exclusively to a single back-end solution (e.g., limiting their ability to integrate with diverse or multiple backend systems) and are rigidly structured to accommodate a predefined set of transactions (e.g., with little flexibility to expand or customize services based on evolving needs or user preferences).

Furthermore, typical automated service systems have limited capabilities for processing and analyzing data (e.g., restricting their ability to generate actionable insights or personalize user interactions), have low scalability (e.g., because of the system architectural constraints, typical automated service systems face challenges in scalability to accommodate growing transaction volumes or expanding service offerings), and have a relatively high dependency on legacy infrastructure (e.g., further limiting the flexibility of typical automated service systems).

Some implementations described herein provide enhanced automated service systems and methods. For example, an automated service system may be used as an assisted-service solution having a flexible system architecture (e.g., the automated service system may interact with multiple backend systems to perform one or more operations and/or one or more transactions). In this way, the automated service system is not limited to performing predefined operations and/or transactions (e.g., because the automated service system may obtain and/or process data from multiple backend systems as needed to perform one or more operations and/or one or more transactions, including complex transactions that are based on data associated with multiple backend systems). Furthermore, this enables the automated service system to have high scalability and without being dependent on legacy infrastructure.

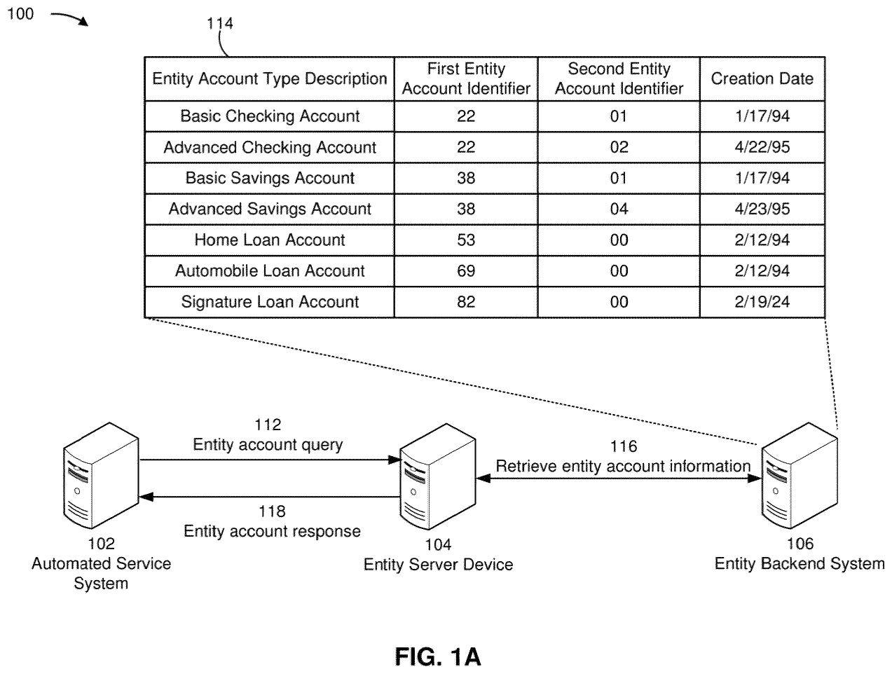

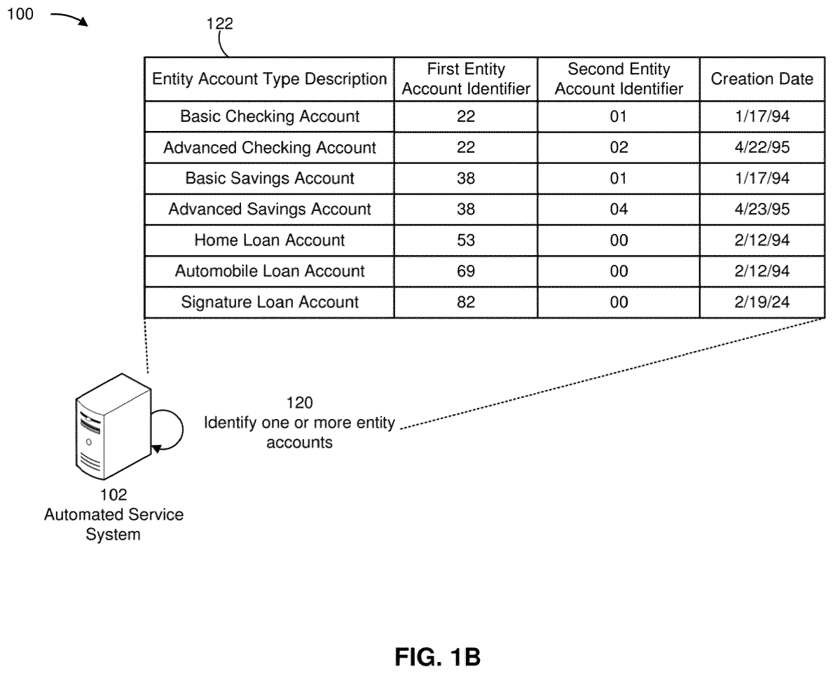

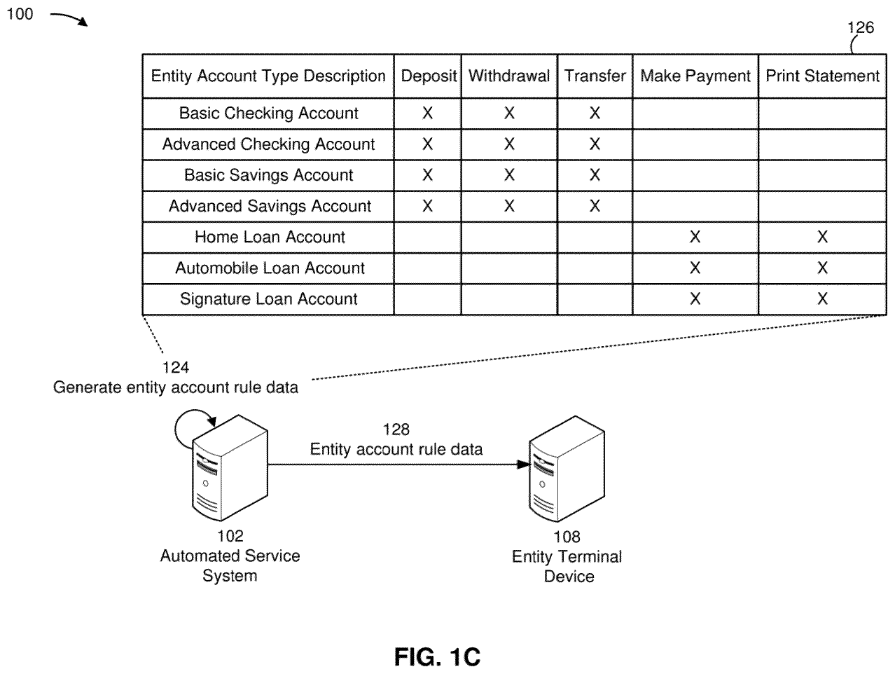

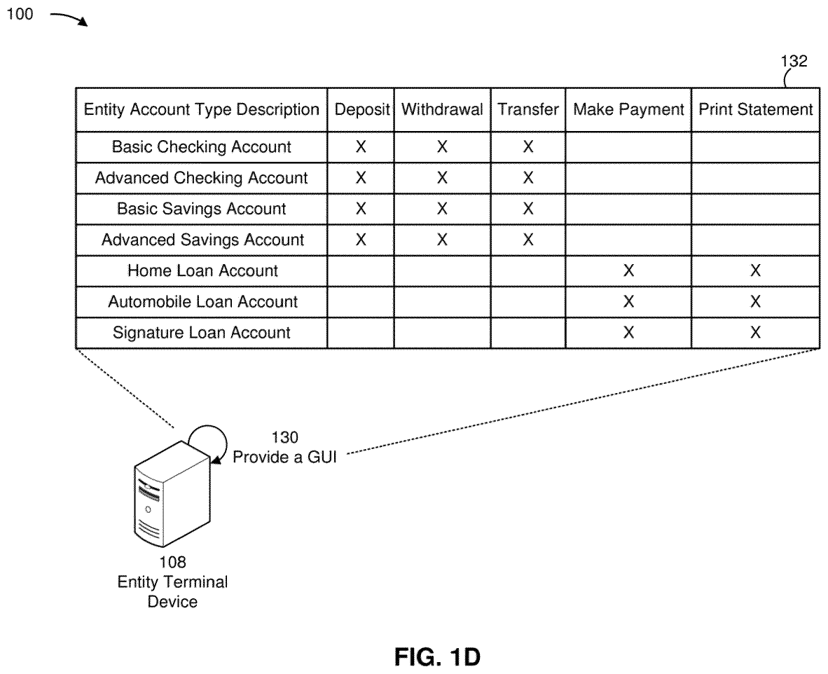

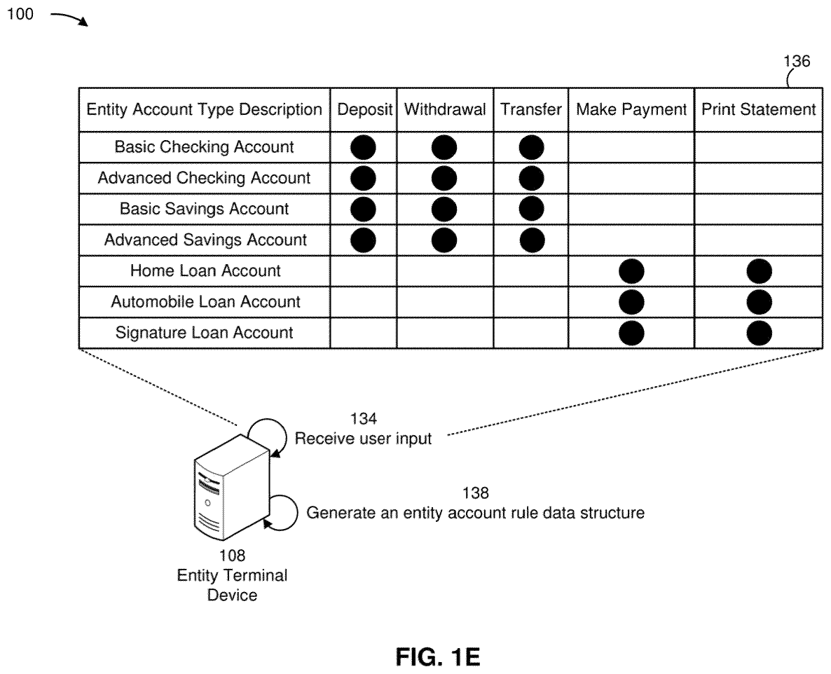

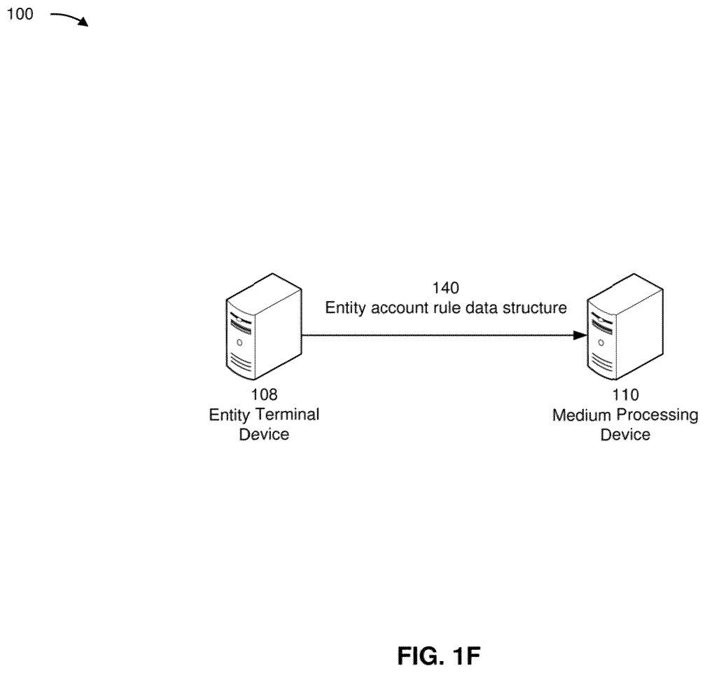

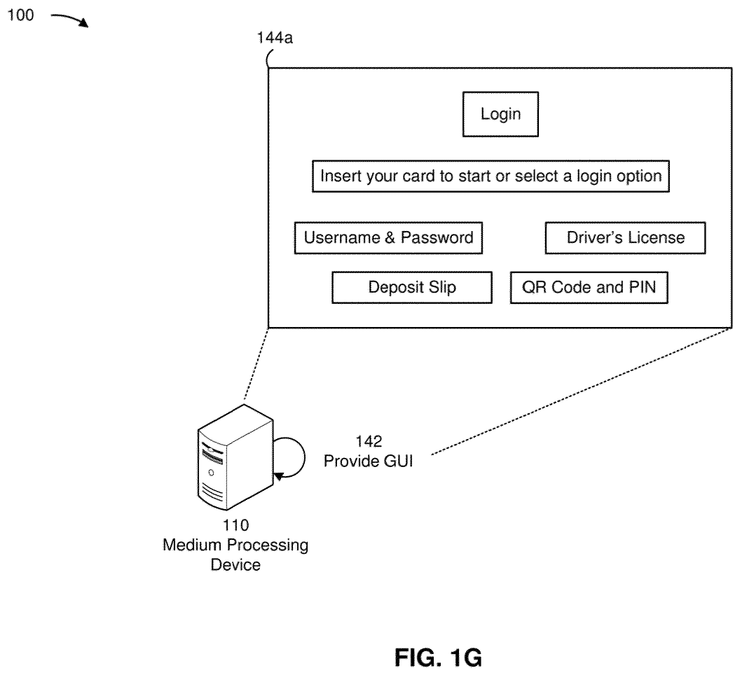

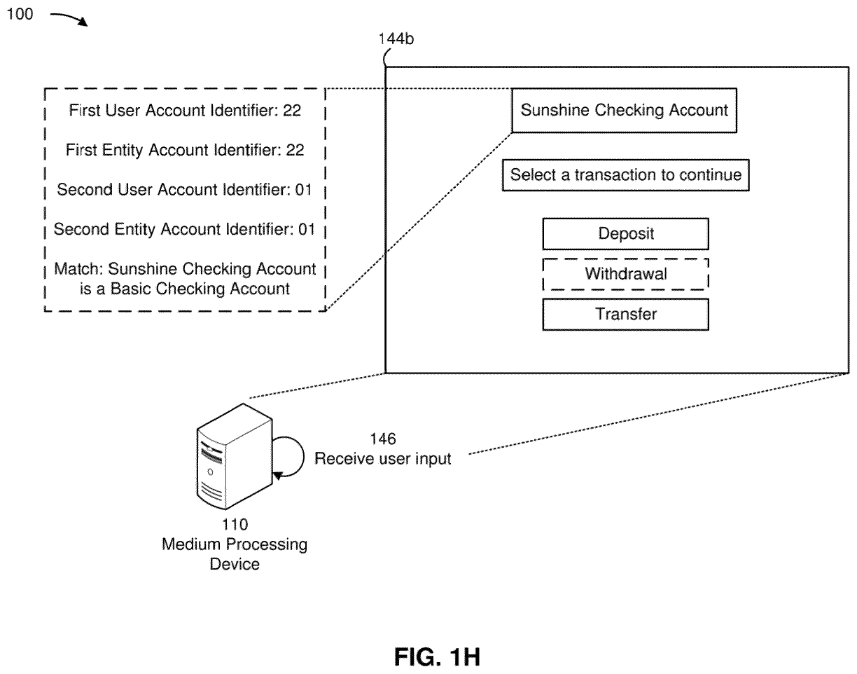

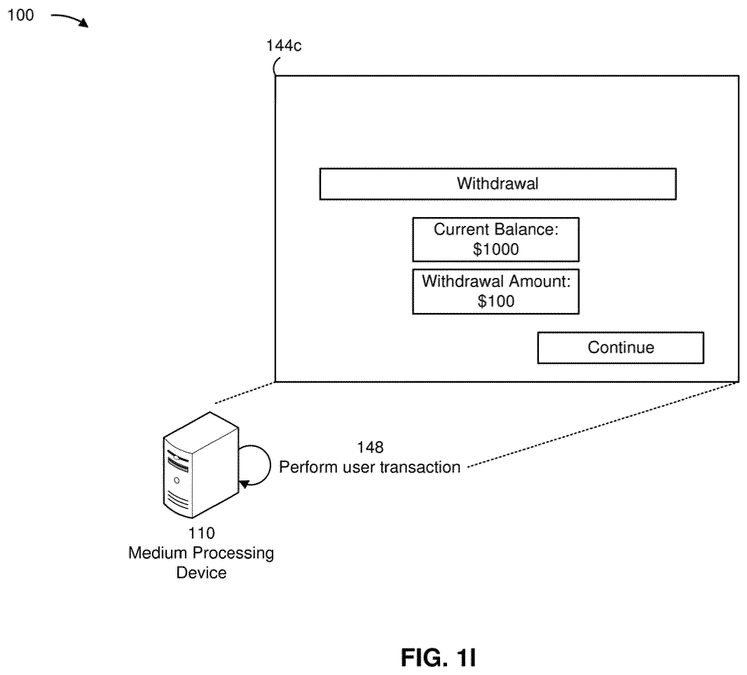

FIGS. 1A-1I are diagrams of an example 100 associated with enhanced automated service systems and methods. As shown in FIGS. 1A-1I, the example 100 includes an automated service system 102, an entity server device 104, an entity backend system 106, an entity terminal device 108, and a medium processing device 110.

As shown in FIG. 1A, and by reference number 112, the automated service system 102 may send, and the entity server device 104 may receive, an entity account query. In some implementations, the entity account query may request information associated with one or more accounts that are managed (or serviced) by an entity. For example, the entity account query may request entity account information associated with one or more accounts managed by a financial institution (e.g., a bank, a lender, a credit card company, or a credit union, among other examples).

In some implementations, the entity account information (e.g., stored by a memory associated with the entity backend system 106, among other examples), may include one or more entity account type descriptions of one or more accounts, one or more identifiers (e.g., one or more unique identifiers) of the one or more accounts, and/or one or more creation dates of the one or more accounts. As shown in FIG. 1A, and by reference number 114, the entity account information includes entity account type descriptions of a basic checking account (e.g., associated with has a first entity account identifier of 22, a second entity account identifier of 01, and a creation date of Jan. 17, 1994), an advanced checking account (e.g., associated with a first entity account identifier of 22, a second entity account identifier of 02, and a creation date of Apr. 22, 1995), a basic savings account (e.g., associated with a first entity account identifier of 38, a second entity account identifier of 01, and a creation date of Jan. 17, 1994), an advanced savings account (e.g., associated with a first entity account identifier of 38, a second entity account identifier of 04, and a creation date of Apr. 23, 1995), a home loan account (e.g., associated with a first entity account identifier of 53, a second entity account identifier of 00, and a creation date of Feb. 12, 1994), and an automobile account (e.g., associated with a first entity account identifier of 69, a second entity account identifier of 00, and a creation date of Feb. 19, 2024). In other words, the first entity account identifier may be associated with a first category (e.g., an account type category, such as a checking account, among other examples) and the second entity account identifier may be associated with a second category, which may be a subcategory of the first category (e.g., a checking account type category, such as a basic checking account, among other examples). This hierarchical approach enables specific identification of accounts within broader categories of accounts, making it easier to manage and distinguish between different types of accounts.

In this way, the entity account information may be used to identify one or more accounts that are managed by the entity, as described in more detail elsewhere herein. Although the entity account information is described as including the one or more entity account type descriptions of the one or more accounts, one or more identifiers (e.g., one or more unique identifiers) of the one or more accounts, and/or one or more creation dates of the one or more accounts in connection with FIG. 1A and reference number 114, the entity account information may include any suitable information associated with the one or more accounts that are managed (or serviced) by the entity.

As further shown in FIG. 1A, and by reference number 116, the entity server device 104 may obtain the entity account information from the entity backend system 106. For example, the entity server device 104 may send, and the entity backend system 106 may receive, a request to obtain the entity account information. The entity backend system 106 may provide the entity account information to the entity server device 104 in response to the request to obtain the entity account information. Although the entity server device 104 is described as obtaining the entity account information from the entity backend system 106, the entity server device 104 may obtain the entity account information in any suitable manner.

As further shown in FIG. 1A, and by reference number 118, the entity server device 104 may send, and the automated service system 102 may receive, an entity account response (e.g., including the entity account information and in response to the entity account query). Although the automated service system 102 is described as receiving the entity account information from the entity server device 104, the automated service system 102 may obtain the entity account information in any suitable manner.

As shown in FIG. 1B, and by reference number 120, the automated service system 102 may identify one or more entity accounts. For example, the automated service system 102 may process the entity account information to identify one or more entity accounts that are managed by an entity (e.g., the financial institution).

As an example, and as shown in FIG. 1A by reference number 122, the automated service system 102 may identify (e.g., based on the entity account information) the basic checking account having the first entity account identifier of 22, the second entity account identifier of 01, and the creation date of Jan. 17, 1994, the advanced checking account having the first entity account identifier of 22, the second entity account identifier of 02, and the creation date of Apr. 22, 1995, the basic savings account having the first entity account identifier of 38, the second entity account identifier of 01, and the creation date of Jan. 17, 1994, the advanced savings account having the first entity account identifier of 38, the second entity account identifier of 04, and the creation date of Apr. 23, 1995, the home loan account having the first entity account identifier of 53, the second entity account identifier of 00, and the creation date of Feb. 12, 1994, the automobile account having the first entity account identifier of 69, the second entity account identifier of 00, and the creation date of Feb. 19, 2024.

In some implementations, the one or more accounts that are managed by the entity may be associated with a set of allowable transactions and a set of rules that govern performance of the set of allowable transactions, as described in more detail elsewhere herein. For example, a first account may be associated with a first set of allowable transactions (e.g., which may be performed according to a first set of rules) and a second account may be associated with a second set of allowable transactions (e.g., that are different than the first set of allowable transactions and which may be performed according to a second set of rules that are different than the first set of rules, among other examples).

In some implementations, the entity server device 104 (or another device associated with the entity) may send, and the automated service system 102 may receive, entity account rule information indicating the set of allowable transactions associated with each of the one or more accounts managed by the entity and the set of rules that govern performance of the set of allowable transactions associated with each of the one or more accounts managed by the entity. The automated service system 102 may process the entity account rule information to identify which transactions may be performed (e.g., related to the one or more accounts that are managed by the entity) by a device associated with the entity (e.g., the medium processing device 110) and which actions the device conducts to perform the transactions, as described in more detail elsewhere herein.

As shown in FIG. 1C, and by reference number 124, the automated service system 102 may generate entity account rule data (e.g., based on the entity account rule information indicating the set of allowable transactions and the set of rules that govern performance of the set of allowable transactions for each of the accounts identified by the automated service system 102). As further shown in FIG. 1C, and by reference number 126, the entity account rule data indicates that the set of allowable transactions associated with the basic checking account, the advanced checking account, the basic savings account, and the advanced savings account include a deposit transaction, a withdrawal transaction, and a transfer transaction and that the set of allowable transactions associated with the home loan account, the automobile loan account, and the signature loan account include a make payment transaction and a print statement transaction. As further shown in FIG. 1C, and by reference number 128, the automated service system 102 may send, and the entity terminal device 108 may receive, the entity account rule data.

As shown in FIG. 1D, and by reference number 130, the entity terminal device 108 may provide a GUI (e.g., a first GUI) via a display of the entity terminal device 108. In some implementations, the GUI may display the entity account rule data (e.g., the entity account type descriptions and/or the set of allowable transactions associated with each of the accounts described or identified by the entity account type descriptions, among other examples). As an example, and as shown by reference number 132 of FIG. 1D, the GUI displays information indicating that set of allowable transactions associated with the basic checking account, the advanced checking account, the basic savings account, and the advanced savings account include the deposit transaction, the withdrawal transaction, and the transfer transaction and that the set of allowable transactions associated with the home loan account, the automobile loan account, and the signature loan account include the make payment transaction and the print statement transaction. The GUI may include one or more input options, corresponding to the allowable transactions for each account or account type, that are selectable by a user via user input, as described in more detail elsewhere herein. As an example, and as shown by reference number 132 of FIG. 1D, each allowable transaction including an x is selectable by the user via the user input.

As shown in FIG. 1E, and by reference number 134, the entity terminal device 108 may receive (e.g., via the GUI) the user input (e.g., from a user associated with the entity, among other examples). In some implementations, the user input indicates a selection of one or more allowable transactions included in the set of allowable transactions (e.g., displayed by the GUI). As an example, and as shown by reference number 136 of FIG. 1E, the user input indicates a selection of a deposit transaction, a withdrawal transaction, and a transfer transaction for the basic checking account, the advanced checking account, the basic savings account, and the advanced savings account and a make payment transaction and a print statement transaction for the home loan account, the automobile loan account, and the signature loan account. In this way, the set of allowable transactions for each account, or account type, managed by the entity may be customized by the user associated with the entity. The selected allowable transactions may be performed by a device (e.g., the medium processing device 110), as described in more detail elsewhere herein.

As further shown in FIG. 1E, and by reference number 138, the entity terminal device 108 may generate an entity account rule data structure. In some implementations, the entity account rule data structure may include information identifying the selected allowable transactions for each account or account type and/or corresponding rules that govern performance of the selected allowable transactions for each account or account type.

As shown in FIG. 1F, and by reference number 140, the entity terminal device 108 may send, and the medium processing device 110 may receive, the entity account rule data structure (e.g., including the information identifying the selected allowable transactions for each account or account type and/or the corresponding rules that govern performance of the selected allowable transactions for each account or account type).

As shown in FIG. 1G, and by reference number 142, the medium processing device 110 may provide a GUI (e.g., a second GUI via a display of the medium processing device 110). In some implementations, the medium processing device 110 may provide the GUI in response to an initial user input provided by a user (e.g., a customer or a non-customer) of the medium processing device 110. As an example, the medium processing device 110 may provide the GUI in response to the user touching the display of the medium processing device 110. The GUI may display login options and the user may provide one or more authentication credentials via one or more authentication options available to the user.

As an example, and as shown by reference number 144a of FIG. 1G, the GUI may display a username and password authentication option, a driver's license authentication option, a deposit slip authentication option, and a QR code and pin authentication option. Although the one or more authentication credentials are shown and described as being provided via the username and password, the driver's license, the deposit slip, and the QR code and pin authentication options, the one or more authentication options may include any suitable authentication options (e.g., a biometric authentication option, a one-time password authentication option, a smart car authentication option, a token authentication option, and/or a multi-factor authentication option, among other examples).

The medium processing device 110 may authenticate the one or more authentication credentials to confirm an identity of the user. In some implementations, the medium processing device 110 may obtain, using the identity of the user, user account data associated with one or more user accounts (e.g., the user account data may indicate one or more names of the one or more user accounts that are managed by the entity, one or more user account identifiers of one or more user accounts that are managed by the entity, and/or user-specific information associated with the one or more user accounts (e.g., a current balance of a checking account, among other examples). As shown by reference number 144b of FIG. 1H, the GUI displays a user account name of Sunshine Checking Account that is associated with three allowable transactions (e.g., a deposit transaction, a withdrawal transaction, and a transfer transaction).

In some implementations, the medium processing device 110 may determine that the one or more user account identifiers of the one or more user accounts match one or more entity account identifiers of one or more entity accounts that are managed by the entity. For example, the medium processing device 110 may compare the one or more user account identifiers and the one or more entity account identifiers that are indicated via the entity account rule data structure. As an example, and as shown in FIG. 1H, the medium processing device 110 determines that the user account (e.g., shown as Sunshine Checking Account in FIG. 1H) is a basic checking account (e.g., as defined by the entity) based on the user account identifiers matching the entity account identifiers (e.g., as shown in FIG. 1H, the first user account identifier of 22 matches the first entity account identifier of 22 and the second user account identifier of 01 matches the second entity account identifier of 01). In other words, the basic checking account may be defined by the entity using the entity account identifiers and the medium processing device 110 may identify the user account based on determining that the user account identifiers match the entity account identifiers. In this way, the medium processing device 110 may automatically perform one or more transactions associated with one or more user accounts that are managed by the entity without prior knowledge of the user account information.

In some implementations, the one or more entity accounts are associated with one or more allowable transactions (e.g., identified by the entity account information) that are performed according to one or more rules (e.g., identified by the entity account information). the performance of the one or more allowable transactions is governed by one or more rules identified by the entity account information.

Accordingly, in some implementations, the medium processing device 110 may identify the one or more allowable transactions as a set of user transaction options corresponding to a set of allowable transactions that are performed according to a set of rules. As an example, and as shown in FIG. 1H, the set of user transaction options includes a deposit transaction, a withdrawal transaction, and a transfer transaction, which correspond to the allowable transactions of the basic checking account (e.g., the deposit transaction, the withdrawal transaction, and the transfer transaction. The medium processing device 110 may display, via the GUI, the set of user transaction options (e.g., as shown in FIG. 1H).

As further shown in FIG. 1H, and by reference number 146, the medium processing device 110 receives, via the GUI, user input indicating a selection of a withdrawal transaction option, which corresponds to the withdrawal transaction associated with the basic checking account. The medium processing device 110 may display information associated with the withdrawal transaction based on the user input indicating a selection of the withdrawal transaction option (e.g., shown by reference number 144c of FIG. 1I as a current balance of $1000 and a withdrawal amount of $100). As further shown in FIG. 1I, and by reference number 148, the medium processing device 110 may perform the withdrawal transaction (e.g., based on interacting with a backend system related to withdrawal transactions) according to the corresponding rules that govern the performance of the withdrawal transaction. Although the medium processing device 110 is described as performing the withdrawal transaction, the medium processing device may perform any suitable transaction (e.g., by accessing one or more backend systems, as needed to perform the transaction.

In this way, the automated service system 102 is not limited to performing predefined operations and/or transactions (e.g., because the automated service system 102 may obtain and/or process data from multiple backend systems as needed to perform one or more operations and/or one or more transactions, including complex transactions that are based on data associated with multiple backend systems). Furthermore, this enables the automated service system to have high scalability and without being dependent on legacy infrastructure.

As indicated above, FIGS. 1A-1I are provided as an example. Other examples may differ from what is described with regard to FIGS. 1A-1I. For example, although the automated service system 102 is described as interacting with devices associated with a single entity, the automated service system may interact with devices associated with multiple entities (e.g., multiple different entities). Accordingly, in some implementations, the automated service system 102 may be used to process information associated with a first account (e.g., account A) managed by a first entity and information associated with a second account (e.g., account B) managed by a second entity (e.g., entity B) that is different than the first account (e.g., the first account may be associated with a first set of allowable transactions governed by a first set of rules defined by the first entity and the second account may be associated with a second set of allowable transactions governed by a second set of rules defined by the second entity.

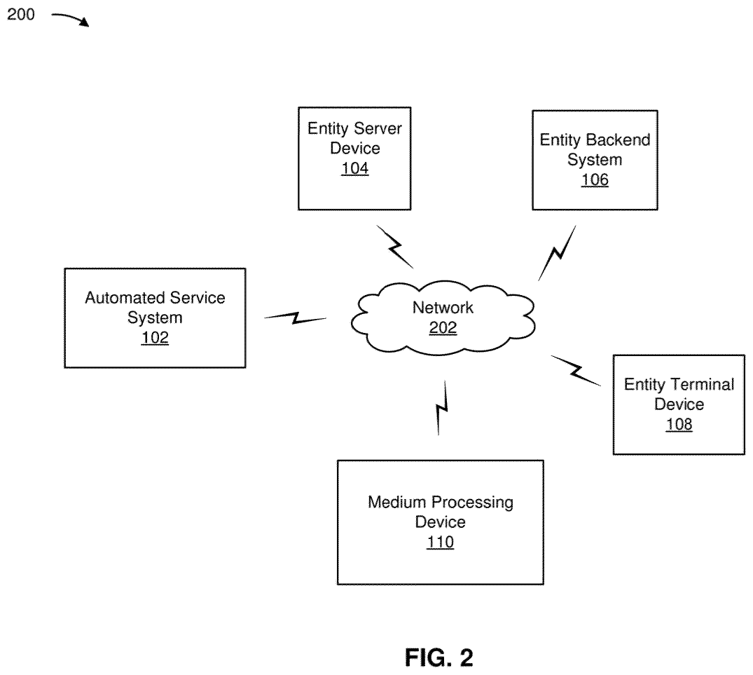

FIG. 2 is a diagram of an example environment 200 in which systems and/or methods described herein may be implemented. As shown in FIG. 2, the environment 200 includes the automated service system 102, the entity server device 104, the entity backend system 106, the entity terminal device 108, the medium processing device 110, and a network 202. The devices of the environment 200 may interconnect via wired connections, wireless connections, or a combination of wired and wireless connections.

The automated service system 102 may include one or more devices capable of receiving, generating, storing, processing, providing, and/or routing information associated with enhanced automated service systems and methods, as described in more detail elsewhere herein. The automated service system 102 may include a communication device and/or a computer. For example, the automated service system 102 may include a server, such as an application server, a client server, a web server, a database server, a host server, a proxy server, a virtual server (e.g., executing on computing hardware), or a server in a cloud computing system, among other examples. In some implementations, the automated service system 102 may include computing hardware used in a cloud computing environment.

The entity server device 104 may include one or more devices capable of receiving, generating, storing, processing, providing, and/or routing information associated with enhanced automated service systems and methods, as described in more detail elsewhere herein. The entity server device 104 may include a communication device and/or a computer. For example, the entity server device 104 may include a server, such as an application server, a client server, a web server, a database server, a host server, a proxy server, a virtual server (e.g., executing on computing hardware), or a server in a cloud computing system, among other examples. In some implementations, the automated service system 102 may include computing hardware used in a cloud computing environment.

The entity backend system 106 may include one or more backend systems (e.g., including software, databases, and/or infrastructure, among other examples) that support operations and/or services associated with an entity. For example, if the entity backend system 106 is associated with a financial institution, then the entity backend system 106 may include one or more systems associated with supporting various aspects of banking transactions and/or banking activities (e.g., user transactions, account management, risk assessment, regulatory compliance, and/or reporting, among other examples).

In some implementations, the entity backend system 106 may include a core banking system (e.g., serving as a central repository for user account information, transaction records, and/or balances, among other examples). The core banking system may be used to facilitate banking functions, such as deposit and withdrawal processing, fund transfers, loan management, and/or interest calculations, among other examples).

In some implementations, the entity backend system 106 may include a payment processing systems that supports (or handles) processing and settlement of various payment transactions, including credit card transactions, automated clearing house (ACH) transfers, wire transfers, and/or electronic funds transfers (EFT), among other examples). In other words, the payment processing system may be used to for movement of funds between accounts and across different payment networks.

In some implementations, the entity backend system 106 may include a risk management system (e.g., for assessing and/or mitigating various types of risks, a compliance and regulatory reporting system (e.g., for automating processes associated with monitoring regulatory compliance, generating required reports, and/or submitting regulatory filings to ensure adherence to applicable laws and regulations, among other examples), and/or a customer relationship management (CRM) system (e.g., for enabling banks to manage their interactions and relationships with users by storing user information, by tracking interactions of users, and/or by facilitating marketing campaigns, among other examples).

Although the entity backend system 106 is described herein as including a core banking system, a payment processing system, a risk management system, a compliance and regulatory reporting system, and a CRM system, the entity backend system 106 may include any suitable backend system.

The entity terminal device 108 may include one or more devices capable of receiving, generating, storing, processing, and/or providing information associated with enhanced automated service systems and methods, as described elsewhere herein. The entity terminal device 108 may include a communication device and/or a computer. For example, the entity terminal device 108 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device, among other examples.

The medium processing device 110 may include one or more devices capable of processing, authorizing, and/or facilitating a transaction. For example, the medium processing device 110 may include one or more servers and/or computing hardware (e.g., in a cloud computing environment or separate from a cloud computing environment, among other examples) configured to receive and/or store information associated with processing an electronic transaction. The medium processing device 110 may process a transaction, such as to approve (e.g., permit, authorize, or the like) or decline (e.g., reject, deny, or the like) the transaction and/or to complete the transaction if the transaction is approved. The medium processing device 110 may process the transaction based on information received from one or more backend systems (e.g., the backend system 106).

The network 202 may include one or more wired and/or wireless networks. For example, the network 202 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks, among other examples. The network 202 enables communication among the devices of environment 200.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

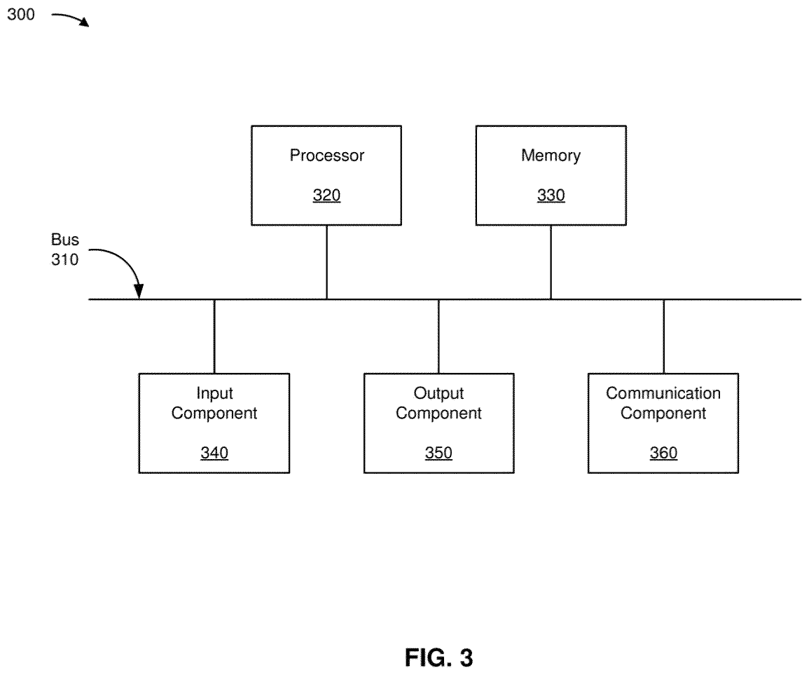

FIG. 3 is a diagram of example components of a device 300 associated with enhanced automated service systems and methods. The device 300 may correspond to the automated service system 102, the entity server device 104, the entity backend system 106, the entity terminal device 108, and/or the medium processing device 110. In some implementations, the automated service system 102, the entity server device 104, the entity backend system 106, the entity terminal device 108, and/or the medium processing device 110 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

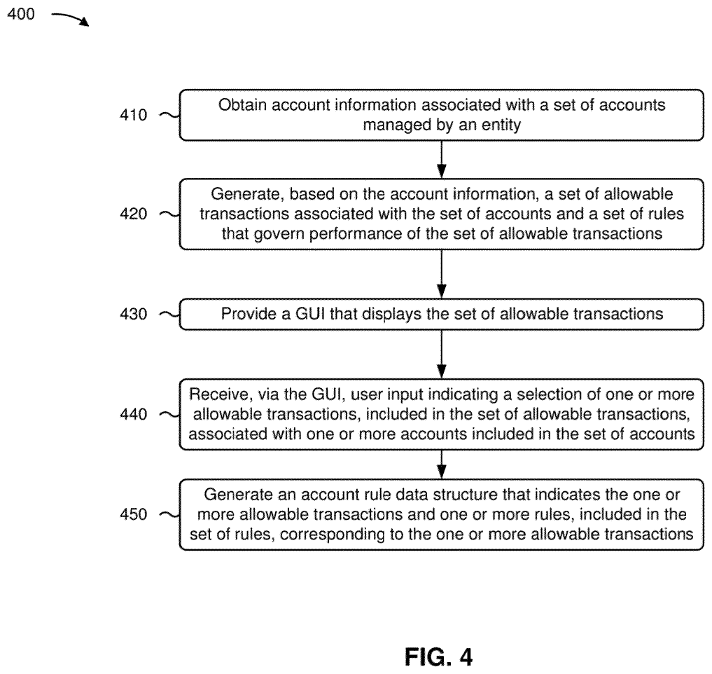

FIG. 4 is a flowchart of an example process 400 associated with enhanced automated service systems and methods. In some implementations, one or more process blocks of FIG. 4 may be performed by the automated service system 102, the entity server device 104, the entity backend system 106, the entity terminal device 108, and/or the medium processing device 110. Additionally, or alternatively, one or more process blocks of FIG. 4 may be performed by one or more components of the device 300, such as the processor 320, the memory 330, the input component 340, the output component 350, and/or the communication component 360.

As shown in FIG. 4, the process 400 includes obtaining account information associated with a set of accounts managed by an entity (block 410). For example, the automated service system 102 may obtain account information associated with a set of accounts managed by an entity, as described in more detail elsewhere herein.

As further shown in FIG. 4, the process 400 includes generating, based on the account information, a set of allowable transactions associated with the set of accounts and a set of rules that govern performance of the set of allowable transactions (block 420). For example, the automated service system 102 may generate, based on the account information, a set of allowable transactions associated with the set of accounts and a set of rules that govern performance of the set of allowable transactions, as described in more detail elsewhere herein.

As further shown in FIG. 4, the process 400 includes providing a GUI that displays the set of allowable transactions (block 430). For example, the automated service system 102 may provide a GUI that displays the set of allowable transactions (e.g., as a set of user transaction options corresponding to the set of allowable transactions), as described in more detail elsewhere herein.

As further shown in FIG. 4, the process 400 includes receiving, via the GUI, user input indicating a selection of one or more allowable transactions, included in the set of allowable transactions, associated with one or more accounts included in the set of accounts (block 440). For example, the automated service system 102 may receive, via the GUI, user input indicating a selection of one or more allowable transactions, included in the set of allowable transactions, associated with one or more accounts included in the set of accounts, as described in more detail elsewhere herein.

As further shown in FIG. 4, the process 400 includes generating an account rule data structure that indicates the one or more allowable transactions and one or more rules, included in the set of rules, corresponding to the one or more allowable transactions (block 450). For example, the automated service system 102 may generate an account rule data structure that indicates the one or more allowable transactions and one or more rules, included in the set of rules, corresponding to the one or more allowable transactions, as described in more detail elsewhere herein.

Although FIG. 4 shows example blocks of the process 400, in some implementations, the process 400 may include additional blocks, fewer blocks, different blocks, or differently arranged blocks than those depicted in FIG. 4. Additionally, or alternatively, two or more of the blocks of the process 400 may be performed in parallel. The process 400 is an example of one process that may be performed by one or more devices described herein. These one or more devices may perform one or more other processes based on operations described herein, such as the operations described in connection with FIGS. 1A-1I. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

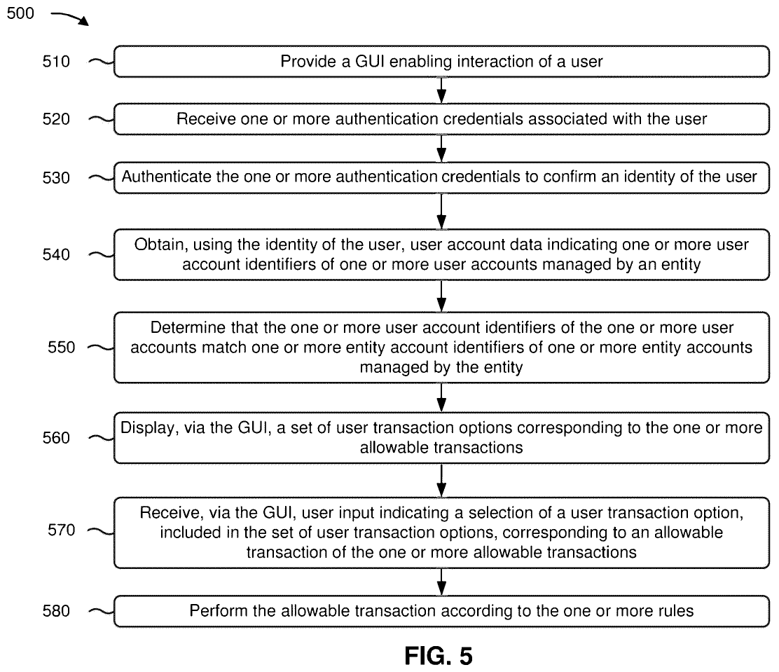

FIG. 5 is a flowchart of an example process 500 associated with enhanced automated service systems and methods. In some implementations, one or more process blocks of FIG. 5 may be performed by the automated service system 102, the entity server device 104, the entity backend system 106, the entity terminal device 108, and/or the medium processing device 110. Additionally, or alternatively, one or more process blocks of FIG. 5 may be performed by one or more components of the device 300, such as the processor 320, the memory 330, the input component 340, the output component 350, and/or the communication component 360.

As shown in FIG. 5, the process 500 includes providing a GUI enabling interaction of a user (block 510). For example, the medium processing device 110 may provide a GUI enabling interaction of a user, as described in more detail elsewhere herein.

As further shown in FIG. 5, the process 500 includes receiving one or more authentication credentials associated with the user (block 520). For example, the medium processing device 110 may receive one or more authentication credentials associated with the user, as described in more detail elsewhere herein.

As further shown in FIG. 5, the process 500 includes authenticating the one or more authentication credentials to confirm an identity of the user (block 530). For example, the medium processing device 110 may authenticate the one or more authentication credentials to confirm an identity of the user, as described in more detail elsewhere herein.

As further shown in FIG. 5, the process 500 includes obtaining, using the identity of the user, user account data indicating one or more user account identifiers of one or more user accounts managed by an entity (block 540). For example, the medium processing device 110 may obtain, using the identity of the user, user account data indicating one or more user account identifiers of one or more user accounts managed by an entity, as described in more detail elsewhere herein.

As further shown in FIG. 5, the process 500 includes determining that the one or more user account identifiers of the one or more user accounts match one or more entity account identifiers of one or more entity accounts managed by the entity (block 550). For example, the medium processing device 110 may determine that the one or more user account identifiers of the one or more user accounts match one or more entity account identifiers of one or more entity accounts managed by the entity, as described in more detail elsewhere herein. In some implementations, the one or more entity accounts may be associated with one or more allowable transactions and performance of the one or more allowable transactions may be governed by one or more rules.

As further shown in FIG. 5, the process 500 includes displaying, via the GUI, a set of user transaction options corresponding to the one or more allowable transactions (block 560). For example, the medium processing device 110 may display, via the GUI, a set of user transaction options corresponding to the one or more allowable transactions, as described in more detail elsewhere herein.

As further shown in FIG. 5, the process 500 includes receiving, via the GUI, user input indicating a selection of a user transaction option, included in the set of user transaction options, corresponding to an allowable transaction of the one or more allowable transactions (block 570). For example, the medium processing device 110 may receive, via the GUI, user input indicating a selection of a user transaction option, included in the set of user transaction options, corresponding to an allowable transaction of the one or more allowable transactions, as described in more detail elsewhere herein. In some implementations, the allowable transaction may be associated with an entity account of the one or more entity accounts.

As further shown in FIG. 5, the process 500 includes performing the allowable transaction according to the one or more rules (block 580). For example, the medium processing device 110 may perform the allowable transaction according to the one or more rules, as described in more detail elsewhere herein.

Although FIG. 5 shows example blocks of the process 500, in some implementations, the process 500 may include additional blocks, fewer blocks, different blocks, or differently arranged blocks than those depicted in FIG. 5. Additionally, or alternatively, two or more of the blocks of the process 500 may be performed in parallel. The process 500 is an example of one process that may be performed by one or more devices described herein. These one or more devices may perform one or more other processes based on operations described herein, such as the operations described in connection with FIGS. 1A-1I. Moreover, while the process 500 has been described in relation to the devices and components of the preceding figures, the process 500 can be performed using alternative, additional, or fewer devices and/or components. Thus, the process 500 is not limited to being performed with the example devices, components, hardware, and software explicitly enumerated in the preceding figures.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A system, comprising:
one or more memories; and
one or more processors, communicably coupled to the one or more memories, configured to:
obtain account information associated with a set of accounts managed by an entity;
generate, based on the account information, a set of allowable transactions associated with the set of accounts and a set of rules that govern performance of the set of allowable transactions;
provide a graphical user interface (GUI) that displays the set of allowable transactions;
receive, via the GUI, user input indicating a selection of one or more allowable transactions, included in the set of allowable transactions, associated with one or more accounts included in the set of accounts; and
generate an account rule data structure that indicates the one or more allowable transactions and one or more rules, included in the set of rules, corresponding to the one or more allowable transactions.

2. The system of claim 1, wherein the account information includes one or more unique identifiers of the one or more accounts.

3. The system of claim 1, wherein the account information is obtained from a backend system associated with the entity.

4. The system of claim 1, wherein the one or more processors are configured to:
provide the account rule data structure to a medium processing device, associated with the entity, that enables the one or more allowable transactions to be performed according to the one or more rules based on user input.

5. The system of claim 1, wherein the one or more processors are configured to:
provide the account rule data structure to a medium processing device, associated with the entity, that enables the one or more accounts to be assigned to a user associated with the entity.

6. The system of claim 1, wherein the entity is a financial institution.

7. The system of claim 1, wherein the one or more rules require obtaining information from multiple backend systems.

8. A medium processing device, comprising:
one or more memories; and
one or more processors, communicably coupled to the one or more memories, configured to:
provide a graphical user interface (GUI) enabling interaction of a user;
receive one or more authentication credentials associated with the user;
authenticate the one or more authentication credentials to confirm an identity of the user;
obtain, using the identity of the user, user account data indicating one or more user account identifiers of one or more user accounts managed by an entity;
determine that the one or more user account identifiers of the one or more user accounts match one or more entity account identifiers of one or more entity accounts managed by the entity,
wherein the one or more entity accounts are associated with one or more allowable transactions, and
wherein performance of the one or more allowable transactions is governed by one or more rules;
display, via the GUI, a set of user transaction options corresponding to the one or more allowable transactions;
receive, via the GUI, user input indicating a selection of a user transaction option, included in the set of user transaction options, corresponding to an allowable transaction of the one or more allowable transactions,
wherein the allowable transaction is associated with an entity account of the one or more entity accounts; and
perform the allowable transaction according to the one or more rules.

9. The medium processing device of claim 8, wherein the user account data is obtained from a backend system associated with the entity.

10. The medium processing device of claim 8, wherein the one or more processors are configured to:
receive entity account information indicating the one or more allowable transactions and the one or more rules.

11. The medium processing device of claim 8, wherein the medium processing device is a self-service kiosk.

12. The medium processing device of claim 8, wherein the entity is a financial institution.

13. The medium processing device of claim 8, wherein the one or more rules require obtaining information from multiple backend systems associated with the entity.

14. The medium processing device of claim 8, wherein the one or more authentication credentials are multi-factor authentication credentials.

15. A non-transitory computer-readable medium storing a set of instructions, the set of instructions comprising:
one or more instructions that, when executed by one or more processors of a system, cause the system to:
obtain account information associated with a set of accounts managed by an entity;
generate, based on the account information, a set of allowable transactions associated with the set of accounts and a set of rules that govern performance of the set of allowable transactions;
provide a graphical user interface (GUI) that displays the set of allowable transactions;
receive, via the GUI, user input indicating a selection of one or more allowable transactions included in the set of allowable transactions,
wherein the one or more allowable transactions are associated with one or more accounts included in the set of accounts; and
generate an account rule data structure that indicates the one or more allowable transactions and one or more rules, included in the set of rules, corresponding to the one or more allowable transactions.

16. The non-transitory computer-readable medium of claim 15, wherein the account information includes one or more unique identifiers of the one or more accounts.

17. The non-transitory computer-readable medium of claim 15, wherein the account information is obtained from a backend system associated with the entity.

18. The non-transitory computer-readable medium of claim 15, wherein the one or more instructions further cause the system to:
provide the account rule data structure to a medium processing device, associated with the entity, that enables the medium processing device to perform the one or more allowable transactions according to the one or more rules, based on user input.

19. The non-transitory computer-readable medium of claim 15, wherein the one or more instructions further cause the system to:
provide the account rule data structure to a medium processing device, associated with the entity, that enables the one or more accounts to be assigned to a user associated with the entity.

20. The non-transitory computer-readable medium of claim 15, wherein the entity is a financial institution.
